(19) United States
(12) Patent Application Publication
(10) Pub. No.: US 2001/0056378 A1
(43) Pub. Date: Dec. 27, 2001

(54) Method and system for managing parts used in fluid machinery

(75) Inventors: Sadao Honjo, Urawa-shi (JP); Toshio Fujino, Kawasaki-shi (JP); Teruo Katayama, Tokyo (JP); Susumu Shiga, Ebina-shi (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: EBARA CORPORATION, Tokyo (JP)

(21) Appl. No.: 09/752,448

(22) Filed: Jan. 3, 2001

(30) Foreign Application Priority Data
Jun. 21, 2000 (JP) 2000-186478

(51) Int. Cl. G06F 17/60

(52) U.S. Cl. 705/26

(57) ABSTRACT

A method and system for managing parts can reduce the delivery time of the parts for fluid machinery such as pumps and can reduce the cost of stocking spare parts for the fluid machinery. The method comprises creating a compatible-parts database for a plurality of fluid machinery of a user in association with a common part used therein. The compatible-parts database identifying a part with a part identifier uniquely predetermined for the part. The method further comprises presenting the compatible-parts database to the user, and ordering a part for fluid machinery from a service provider by referring to the compatible-parts database.

### BACKGROUND OF THE INVENTION

1. Field of the Invention

The present invention relates to a method and system for managing parts used in various types of fluid machinery installed in chemical plants or other plants, and more particularly to a method and system for managing parts that can reduce the delivery time of the parts for fluid machinery such as pumps and can reduce the cost of stocking spare parts for the fluid machinery. Further, the present invention relates to a method for ordering such parts.

1. Description of the Related Art

Many types of fluid machinery including pumps and blowers are installed and operated in chemical plants or other plants. When these types of fluid machinery are forced to be shut down due to damage of parts used therein, particularly expendable parts, it may be necessary to halt production in the entire plant. Stoppage of production in the entire plant or a part of the plant brings an enormous loss to the plant operator (hereinafter referred to as the user). Therefore, the user maintains many stocks of spare parts to facilitate the speedy repair of fluid machinery in the event of a breakdown.

Generally, these parts are not commercially sold and need to be ordered directly from the manufacturer of the fluid machinery. After receiving orders for parts, the manufacturer estimates a price for the parts and manufactures the necessary number of parts at that time. Accordingly, it takes a considerable amount of time for the user to receive parts that have been ordered, and hence the user needs to maintain many stocks of spare parts as described above.

Thus, since the user needs to maintain many stocks of spare parts for each of parts used in fluid machinery, the cost of keeping various spare parts in reserve imposes a great burden on the user.

### SUMMARY OF THE INVENTION

The present invention has been made in view of the above drawbacks. It is therefore an object of the present invention to provide a method and system for managing parts that can reduce the delivery time of the parts for fluid machinery such as pumps and can reduce the cost of stocking spare parts for the fluid machinery. Further, another object of the present invention is to provide a method for ordering such parts.

According to a first aspect of the present invention, there is provided a method for managing parts used in fluid machinery comprising: creating a compatible-parts database for a plurality of fluid machinery in association with a common part used therein, the compatible-parts database identifying a part with a part identifier uniquely predetermined for the part.

According to a second aspect of the present invention, there is provided a method for ordering parts used in fluid machinery comprising: creating a compatible-parts database for a plurality of fluid machinery of a user in association with a common part used therein, the compatible-parts database identifying a part with a part identifier uniquely predetermined for the part; presenting the compatible-parts database to the user; and ordering a part for fluid machinery from a service provider by referring to the compatible-parts database.

With these methods, the user can easily find what common parts are used in the user's current fluid machinery. Accordingly, the user can reduce the number of spare parts which have been redundantly stocked to a minimum required number, or eliminate the stocking of spare parts altogether.

Further, since it is possible to simplify service provider's process of estimation, receiving an order, manufacturing, and the like, the time required to deliver parts for fluid machinery such as pumps can be reduced. Accordingly, the user can reduce or eliminate the number of the user's own stocked spare parts for fluid machinery.

In a preferred aspect of the present invention, the method for ordering parts used in fluid machinery further comprising: presenting a control identifier assigned for a part used in the user's fluid machinery to the service provider; and associating the fluid machinery in the compatible-parts database with the control identifier.

With this method, the user can manage the parts based on the user's own control identifier and can simultaneously order a part for fluid machinery with the service provider's part identifier by referring to the compatible-parts database.

In a preferred aspect of the present invention, the user orders a part for fluid machinery from the service provider based on the control identifier corresponding to the part. Thus, the user can order a part for fluid machinery with the user's own control identifier.

In a preferred aspect of the present invention, information communicated between the user and the service provider is transmitted via a storage medium storing the information, the storage medium capable of being read by a computer.

In a preferred aspect of the present invention, information communicated between the user and the service provider is transmitted by a client terminal on the user end and a server on the service provider end connected to each other via a network.

In this case, information can be quickly transmitted between the user and the service provider. This can reduce the delivery time of the parts for fluid machinery more effectively. Specifically, in the case where the user orders a part from the service provider via the network, it is possible to decrease the time required from order to delivery of the part. Therefore, the user can reduce the number of spare parts in stock, or eliminate the stock altogether.

In a preferred aspect of the present invention, a parts center serving as a regional base for distributing parts performs a part of the role or the entire role of the service provider.

In this case, when the user orders a part, the part can be delivered from the parts center nearest to the user for thereby speeding up the distribution process. Further, the parts center can manage and stock spare parts for a plurality of users in the neighboring areas.

In a preferred aspect of the present invention, the service provider regularly or irregularly acquires information for fluid machinery employed by the user to update the compatible-parts database. With this method, the service provider can always maintain the latest data in the compatible-parts database.

In a preferred aspect of the present invention, the method for ordering parts used in fluid machinery further comprising: associating the part in the compatible-parts database with the status of parts stocked by at least one of the service provider and the user; and regularly or irregularly acquiring information for parts stocked by the at least one of the service provider and the user to update the compatible-parts database.

In this case, it is possible to easily find the current state of stocked parts by the user, the service provider, or both, so that the management of stocked parts can be facilitated.

In a preferred aspect of the present invention, the service provider procures a part used in fluid machinery from the same users or different users.

In a preferred aspect of the present invention, the service provider manages maintenance of fluid machinery employed by the user based on information stored in the compatible-parts database.

According to another aspect of the present invention, there is provided a system for managing parts used in fluid machinery comprising: a compatible-parts database for a plurality of fluid machinery of a user in association with a common part used therein, the compatible-parts database identifying a part with a part identifier uniquely predetermined for the part; an input device for inputting a search condition for searching the compatible-parts database; a search component for searching the compatible-parts database for a part of fluid machinery that matches the search condition inputted by the input device; and a display device for displaying information on the part searched out by the searching component.

In a preferred aspect of the present invention, the fluid machinery in the compatible-parts database is associated with a control identifier assigned for a part used in the user's fluid machinery.

According to the present invention, since the user can instantaneously and easily find what common parts are used in the user's current fluid machinery. Therefore, the user can reduce the number of spare parts which have been redundantly stocked to a minimum required number, or eliminate the stocking of spare parts altogether. Further, the user can easily find a service provider's part identifier from the user's own control identifier used in the user's production process.

The above and other objects, features, and advantages of the present invention will be apparent from the following description when taken in conjunction with the accompanying drawings which illustrates preferred embodiments of the present invention by way of example.

### BRIEF DESCRIPTION OF THE DRAWINGS

FIG. 1 is a flowchart showing a process in a method for managing parts used in fluid machinery according to an embodiment of the present invention;

FIG. 2 is a schematic view showing an example of a data sheet for a user to enter information on existing pumps in;

FIG. 3 is a schematic view showing an example of a compatible-parts database according to the embodiment of the present invention;

FIG. 4 is a schematic view showing an example of a compatible-parts database including control numbers according to the embodiment of the present invention;

FIG. 5 is a block diagram showing an example of a hardware construction in a parts management apparatus according to the embodiment of the present invention;

FIG. 6 is a schematic view showing an example of a search window displayed on a display device of the parts management apparatus;

FIG. 7 is a flowchart showing a process of searching for a part code and the control number corresponding to a specified part with the parts management apparatus;

FIG. 8 is a flowchart showing a process of searching for all pumps including parts corresponding to a specified part code;

FIG. 9 is a schematic view showing an example of a window displayed on the display device of the parts management apparatus;

FIG. 10 is a flowchart showing a process of searching for all pumps including parts corresponding to a specified control number;

FIG. 11 is a schematic view showing an example of a window displayed on the display device of the parts management apparatus;

FIG. 12 is a flowchart showing a process of searching for all parts used in a specified pump;

FIG. 13 a schematic view showing an example of a window displayed on the display device of the parts management apparatus; and

FIG. 14 is a schematic view showing a construction of a network according to another embodiment of the present invention.

### DETAILED DESCRIPTION OF THE PREFERRED EMBODIMENTS

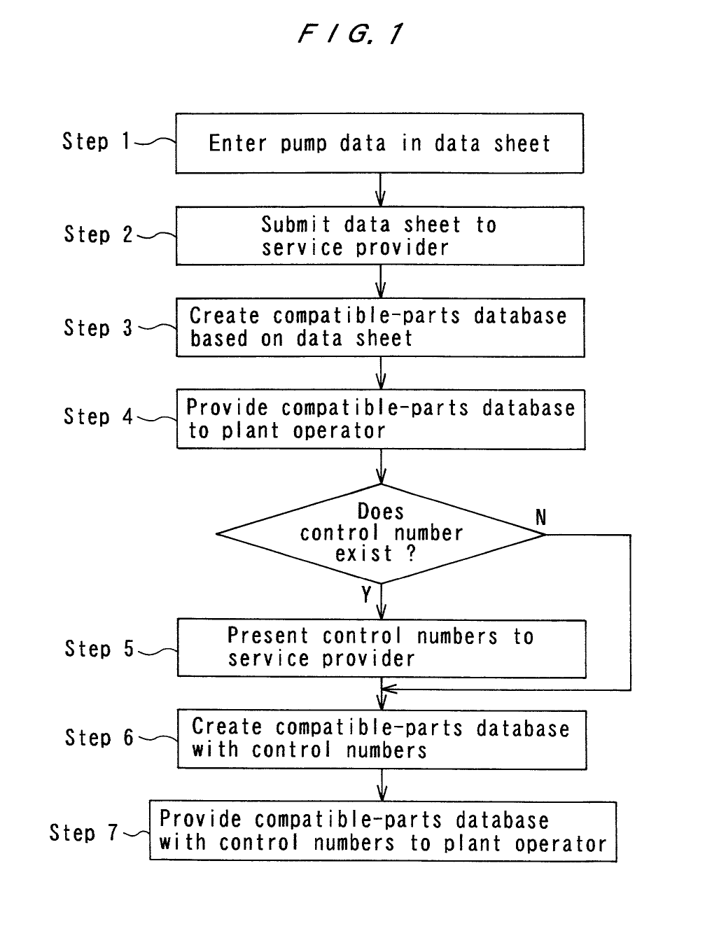

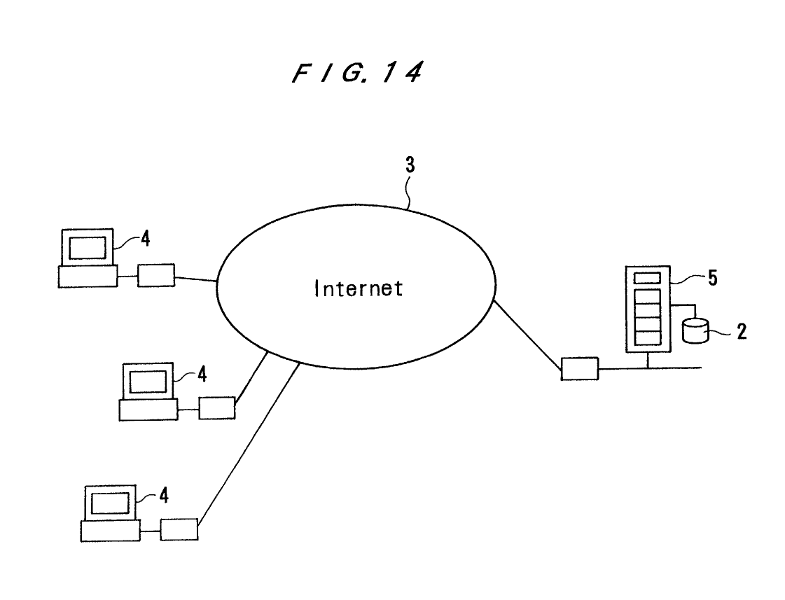

A method and system for managing parts used in fluid machinery and a method for ordering such parts according to an embodiment of the present invention will be described below with reference to FIGS. 1 through 14. This type of fluid machinery includes a pump, a blower, a turbine, and the like. In the present embodiment, a pump will be described as an example of the fluid machinery. Further, in the present embodiment, a plant operator will be described as the user.

FIG. 1 is a flowchart showing the process in a method for managing parts used in fluid machinery according to the present embodiment.

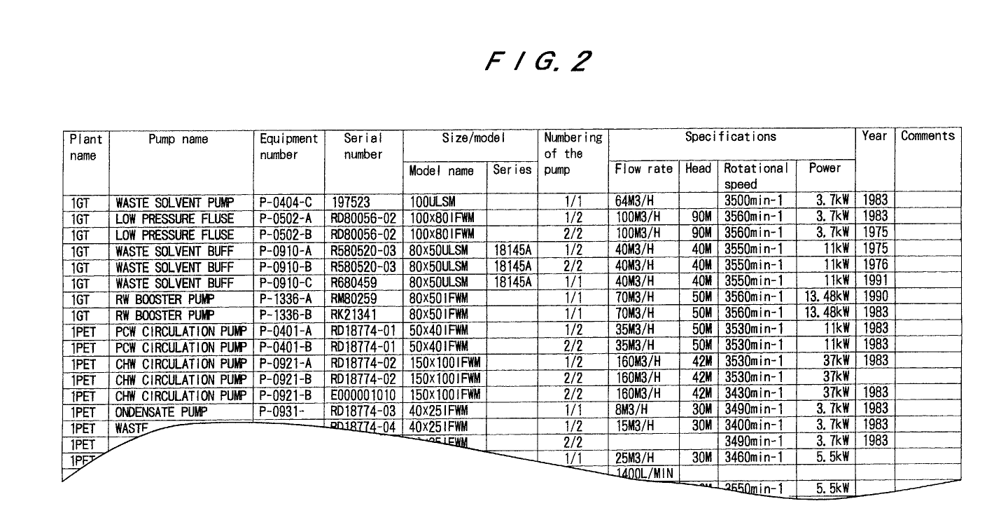

First, a plant operator (i.e., user) of a plant having a plurality of pumps installed therein enters prescribed data in a prepared data sheet to identify pumps operating at the plant (Step 1). The data sheet is provided by a service provider, who offers the system according to the present invention. An example of the data sheet is shown in FIG. 2. As shown in FIG. 2, the user's plant and the pumps currently operated therein (hereinafter referred to as the operating pumps) are identified by the data sheet in which the user enters data such as the plant name, the pump name, the equipment number, the serial number, the size/model, the numbering of the pump, and the specifications.

The manufacturer, dealer (distributor), or maintenance company of the fluid machinery and/or parts used therein, or a parts center can perform a part of the role or the entire role of the service provider. A parts center is disposed as a regional base for distributing parts. When the user orders a part (or parts), the part (or parts) can be delivered from the parts center nearest to the user for thereby speeding up the distribution process. Further, the parts center can manage and stock spare parts for a plurality of users in the neighboring areas.

Preferably, the manufacturer of the fluid machinery and the like should create a compatible-parts database described later based on actual production data. In the description below, it is assumed that the service provider is the manufacturer and dealer of the pumps and has supplied the pumps to the user.

The user submits the data sheet to the service provider (Step 2). The service provider refers to the data sheet to realize what pumps are operated at the user's plant. If the service provider has supplied these pumps to the user, then the service provider should already know what pumps are operated at the user's plant. However, if the pumps have been removed or relocated after installation due to alterations of the plant facilities and the like, then the service provider cannot receive information about the pumps that have been removed or relocated. Therefore, in this case, the service provider cannot accurately realize what pumps are currently operated. Accordingly, the service provider can accurately realize the currently operating pumps by referring to the data sheet.

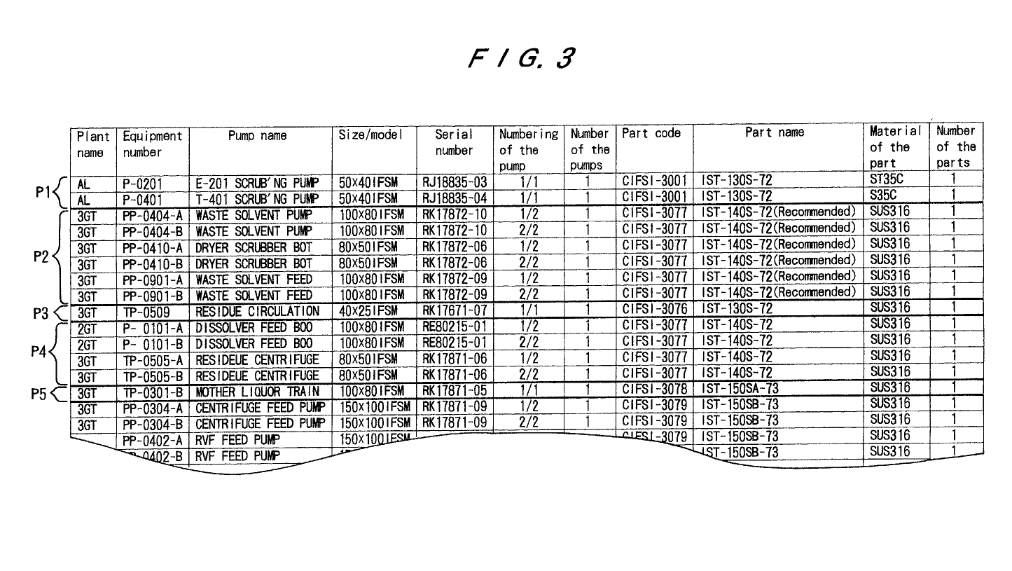

The service provider creates a list called a compatible-parts database for groups of operating pumps including the same parts, based on data recorded on the data sheet (Step 3). If the service provider is a manufacturer of the pumps, the service provider can realize, from the actual production data, what parts are used in the pumps. Based on this actual production data, the service provider can create a compatible-parts database as shown in FIG. 3 by extracting common parts used in the operating pumps identified by the data sheet. The common part is a part common to a plurality of pumps. As shown in FIG. 3, the compatible-parts database includes data such as the plant name, the pump name, the equipment number, the serial number, the size/model, the numbering of the pump, the number of the pumps, the part code, the part name, the material of the part, and the number of the parts. In FIG. 3, groups of pumps P1 to P5 including the same parts are listed together.

In order to manufacture and manage these parts effectively, the service provider assigns a part code (part identifier) uniquely predetermined for each of parts to the part. In the compatible-parts database shown in FIG. 3, each of the parts is identified not only by a part name, but also by this part code.

The service provider provides this compatible-parts database to the user (Step 4). The compatible-parts database can be provided on various types of media, for example, a paper or an electronic storage medium such as a floppy disk.

Generally, the user cannot know whether the exact same parts are used in different pumps at the user's plant or not. Specifically, since the user has no information such as the actual production data possessed by the manufacturer, the user cannot know whether common parts are used in the operating pumps or not. Therefore, the user may be unknowingly stocking duplicate spare parts for these common parts.

According to the present invention, the user can find common parts used in the operating pumps by referring to the compatible-parts database provided by the service provider. Therefore, the user can reduce the number of spare parts stocked for the common parts to a minimum required number, or eliminate the stocking of spare parts altogether. For example, on the assumption that one spare part is stocked for each of parts, a part common to five pumps conventionally requires that five spare parts should be stocked. However, according to the present invention, the user needs to stock only one part and, in some cases, none at all. Thus, the compatible-parts database can reduce the number of spare parts stocked, thereby greatly reducing the cost for spare parts or eliminating the cost altogether.

Due to the need to manage stocked spare parts, the user may assign an independent control number (control identifier) to each of parts used in fluid machinery at the plant. In such a case, the user presents those control numbers to the service provider (Step 5). The service provider may create a new compatible-parts database that further correlates the control numbers with each of data (pump name, part code, etc.) in the compatible-parts database described above (Step 6).

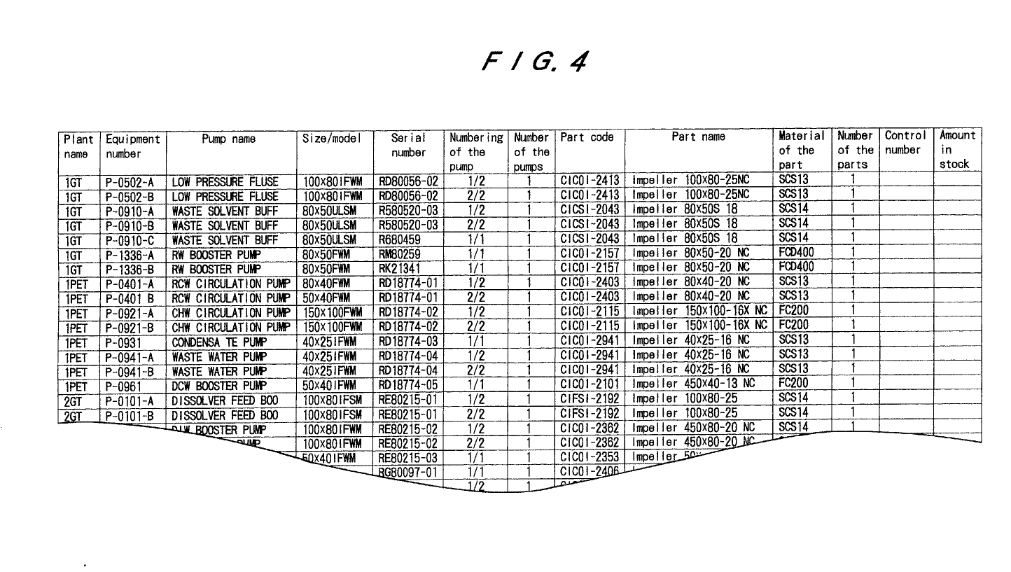

FIG. 4 shows an example of a compatible-parts database with an added column for the control numbers. As shown in FIG. 4, this compatible-parts database includes such data as the plant name, the pump name, the equipment number, the serial number, the size/model, the numbering of the pump, the number of the pumps, the part code, the part name, the material of the part, the number of the parts, the user's control number, and the amount in stock. Here, the control number (control identifier) is associated with each of data in the compatible-parts database. Since each of data in the compatible-parts database is also associated with a part code, each of the control numbers is associated with a part code. If the user has not assigned an independent control number, it is not necessary to present control numbers as described in Step 5, and the control number column in the compatible-parts database created in Step 6 may be left blank.

The service provider provides this new compatible-parts database to the user (Step 7). The compatible-parts database can be provided on any of various media. In the present embodiment, the compatible-parts database is provided on an electronic storage medium such as a floppy disk.

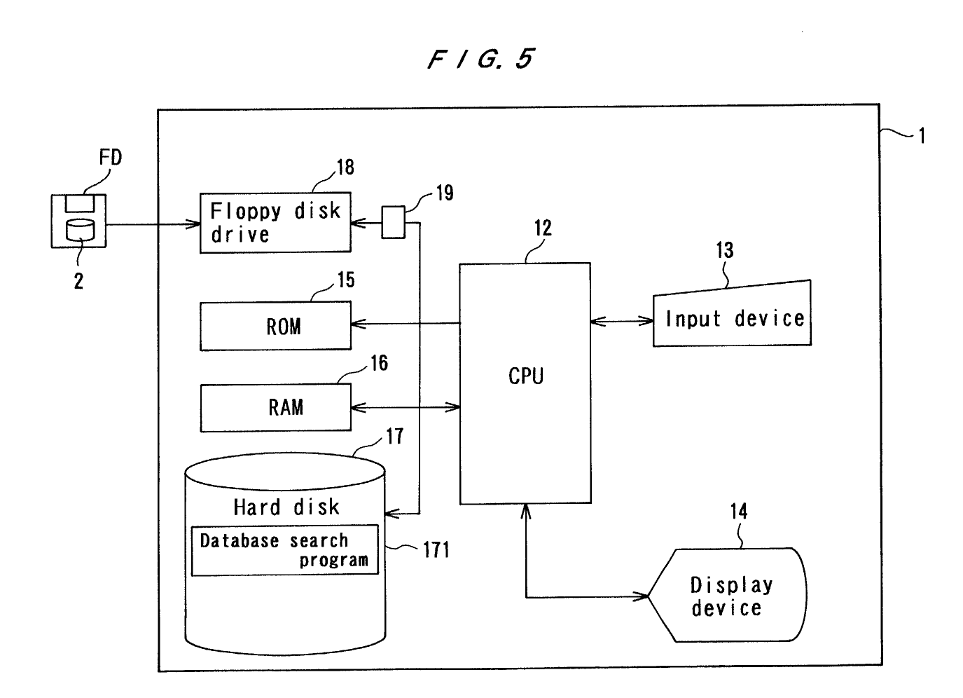

Next, a parts management apparatus employing the aforementioned compatible-parts database with control numbers will be described below. In the present embodiment, the parts management apparatus is installed on the user's end, and the compatible-parts database is provided on a floppy disk. FIG. 5 is a block diagram showing an example of a hardware construction in the parts management apparatus according to the present embodiment.

The parts management apparatus 1 is configured by a personal computer or the like. As shown in FIG. 5, the parts management apparatus 1 comprises a central processing unit (CPU) 12, an input device 13 such as a keyboard or a mouse, a display device 14 such as a monitor, storage devices including a ROM 15, a RAM 16, and a hard disk 17, a floppy disk drive 18 as an auxiliary storage device, and a floppy disk controller 19.

A floppy disk FD provided by the service provider is inserted into the floppy disk drive 18. The floppy disk FD stores a compatible-parts database 2. The data stored on this floppy disk FD are read by the floppy disk controller 19 and the CPU 12.

Computer program codes for issuing commands to the CPU 12 and the like are stored with the storage devices 15 to 17 to perform operations in cooperation with an operating system (OS). One of these computer programs stored with the storage devices 15 to 17 is a database search program 171. The database search program 171 is loaded into the RAM 16 for execution to constitute a search component for searching the compatible-parts database 2 stored on the floppy disk FD for data meeting specified search conditions.

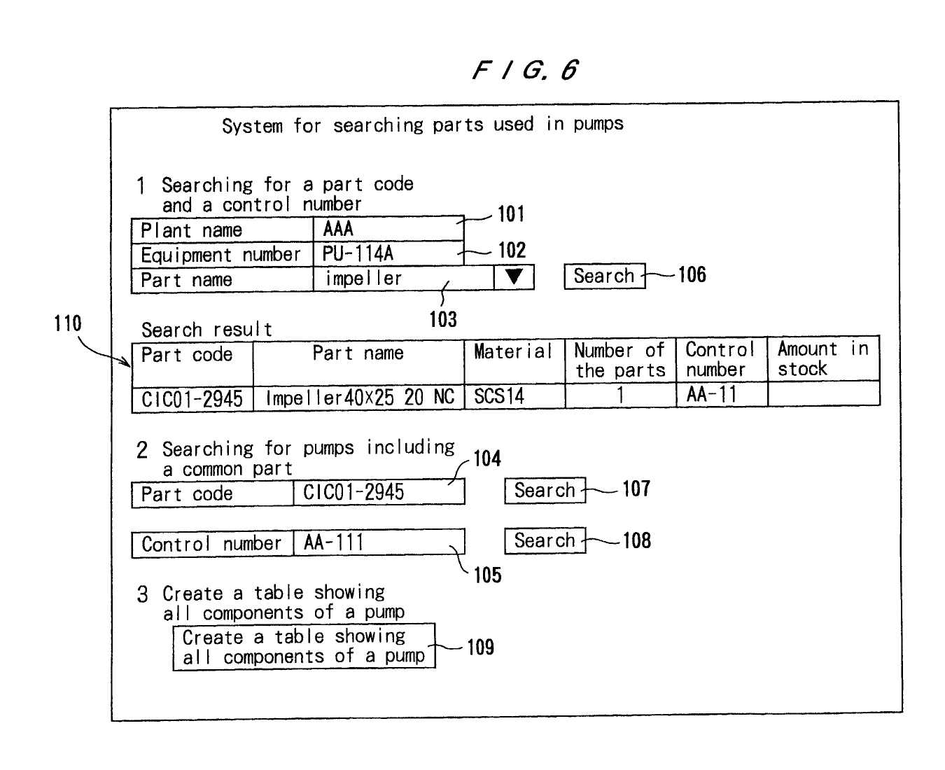

When the database search program 171 is executed, a search window as shown in FIG. 6 is displayed on the display device 14. As shown in FIG. 6, the search window includes a field 101 for inputting a plant name, a field 102 for inputting an equipment number, a combo box 103 for selecting a part name, a field 104 for inputting a part code, a field 105 for inputting a control number, search buttons 106 to 108 for starting a search based on the corresponding search conditions, and a button 109 for creating a table showing all components of a pump. By operating the input device 13 such as a mouse, the user can instruct the database search program 171 to perform any of the following processes.

(1) Search for a part code and a control number corresponding to a specified part

(2) Search for all pumps including parts corresponding to a specified part code

(3) Search for all pumps including parts corresponding to a specified control number

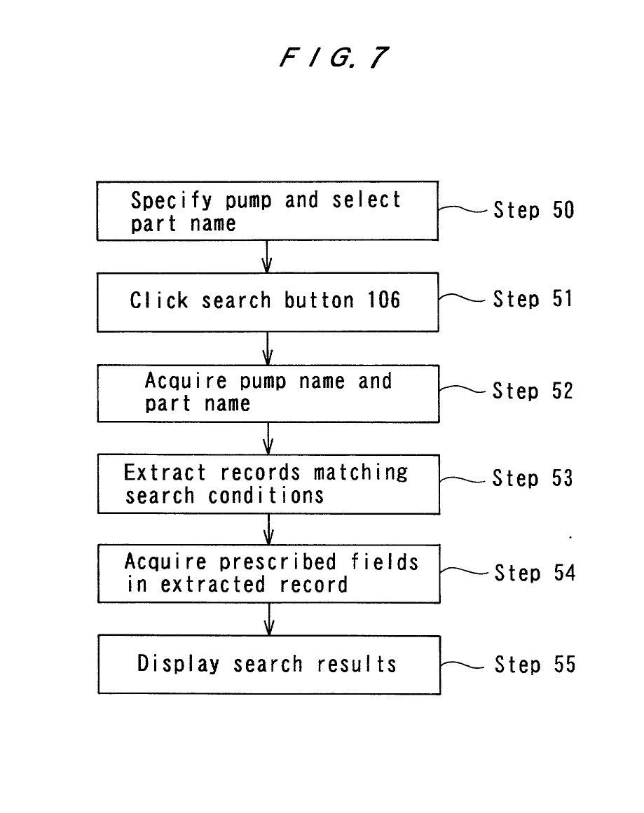

(4) Search for all parts used in a specified pump The process (1) of searching for a part code and a control number corresponding to a specified part will be described below. FIG. 7 is a flowchart showing this process.

The user inputs a plant name and an equipment number into the fields 101 and 102 and specifies a target pump for the search. Using the combo box 103, the user selects a part name for the search (Step 50). The user can select a part name from a plurality of part names such as an impeller, a shaft, and an impeller nut, with the combo box 103. When the user clicks the search button 106 (Step 51), the pump name and the equipment name inputted into the fields 101, 102, and the part name selected with the combo box 103 are acquired by the search component (Step 52). The acquired data is set as search conditions for searching the compatible-parts database 2 stored on the floppy disk FD, and the search component extracts records matching these search conditions from the compatible-parts database 2 (Step 53). Fields for the part code, the part name, the material of the part, the quantity, the control number, and the amount in stock are read from the extracted records (Step 54). The values for each of the fields are displayed in a search result column 110 in the search window of FIG. 6 (Step 55). Thus, by simply specifying the pump and the part name, the user can easily find the part code and the control number corresponding to the part.

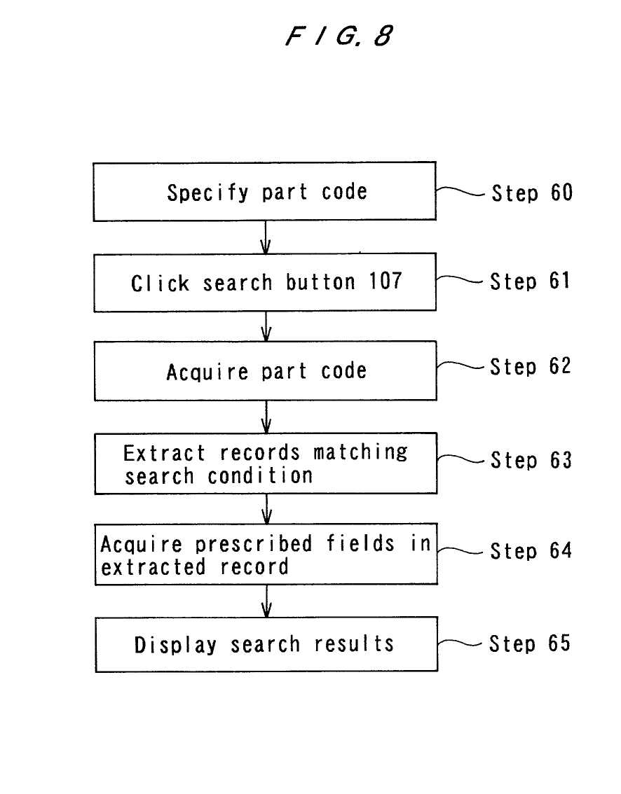

Next, the process (2) of searching for all pumps including parts corresponding to a specified part code will be described below. FIG. 8 is a flowchart showing this process.

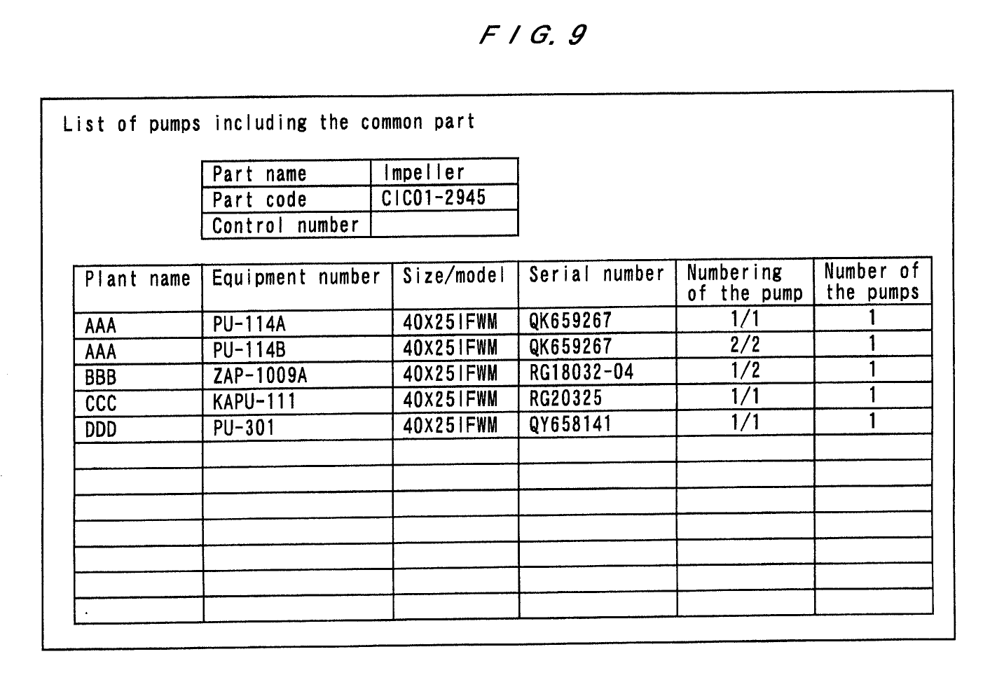

The user specifies a part code for the search by inputting a part code into the field 104 (Step 60). When the user clicks the search button 107 (Step 61), the part code inputted into the field 104 is acquired by the search component (Step 62). The acquired data is set as a search condition for searching the compatible-parts database 2 stored on the floppy disk FD, and the search component extracts records matching this search condition from the compatible-parts database 2 (Step 63). Fields for the plant name, the equipment number, the size/model, the serial number, the numbering of the pump, and the number of the pumps are read from the extracted records (Step 64). The values for each of the fields are displayed in the display device 14, as shown in FIG. 9 (Step 65). Thus, by simply specifying the part code, the user can find all pumps including the part corresponding to this part code, so that the management of stocked spare parts can be facilitated.

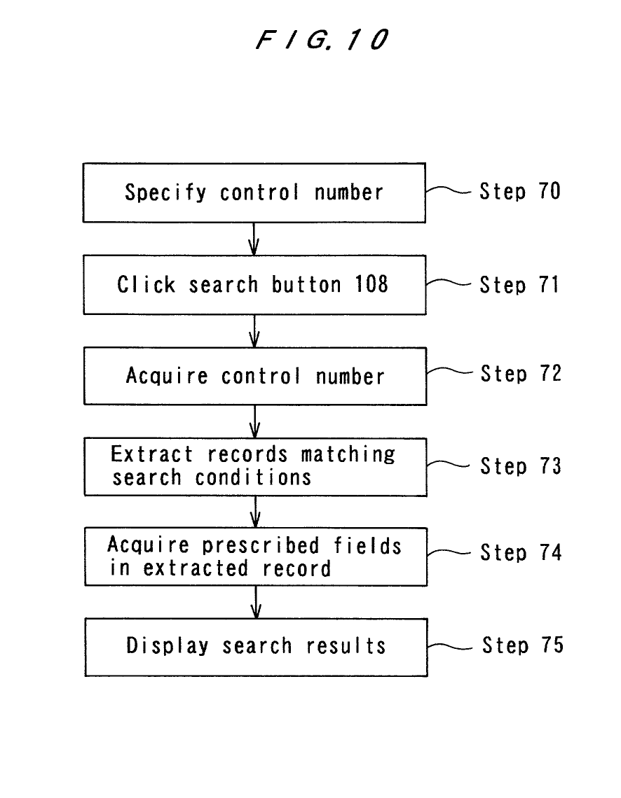

Next, the process (3) of searching for all pumps including parts corresponding to a specified control number will be described below. FIG. 10 is a flowchart showing this process.

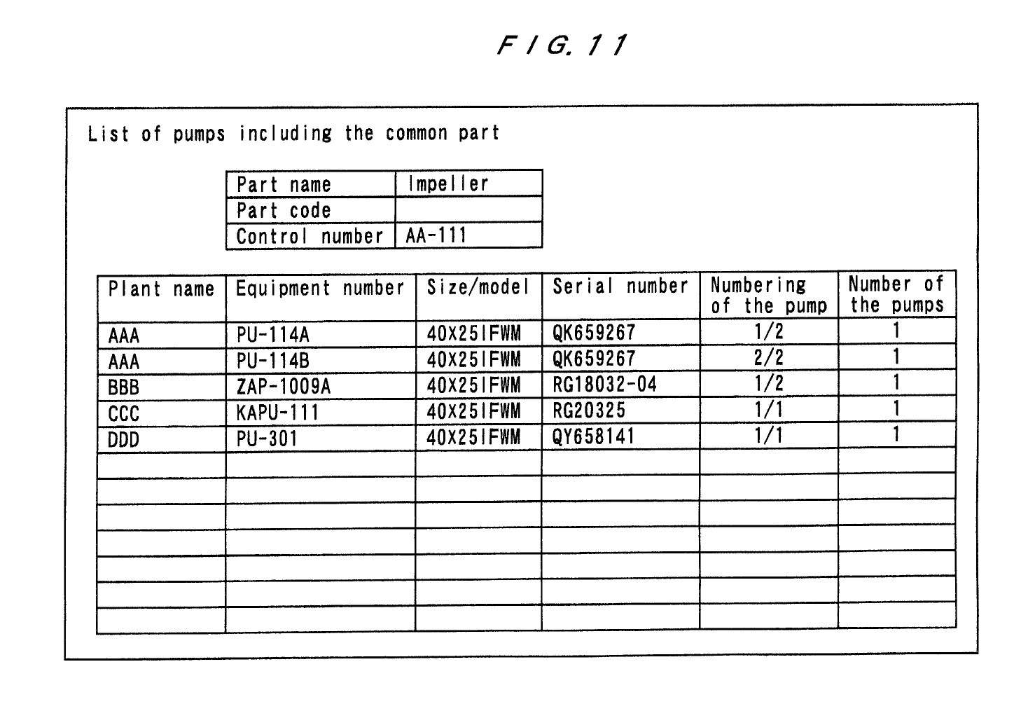

The user specifies a control number for the search by inputting a control number into the field 105 (Step 70). When the user clicks the search button 108 (Step 71), the control number inputted into the field 105 is acquired by the search component (Step 72). The acquired data is set as a search condition for searching the compatible-parts database 2 stored on the floppy disk FD, and the search component extracts records matching this search condition from the compatible-parts database 2 (Step 73). Fields for the plant name, the equipment number, the size/model, the serial number, the numbering of the pump, and the number of the pumps are read from the extracted records (Step 74). The values for each of the fields are displayed in the display device 14, as shown in FIG. 11 (Step 75). Thus, by simply specifying the control number, the user can find all pumps including the part corresponding to this control number and the part code corresponding to this control number, so that the management of stocked spare parts can be facilitated.

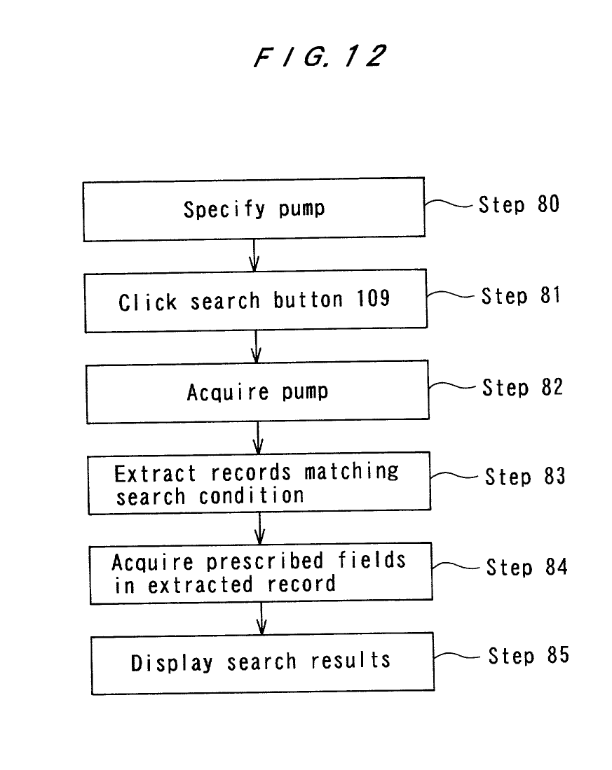

Next, the process (4) of searching for all parts used in a specified pump will be described below. FIG. 12 is a flowchart showing this process.

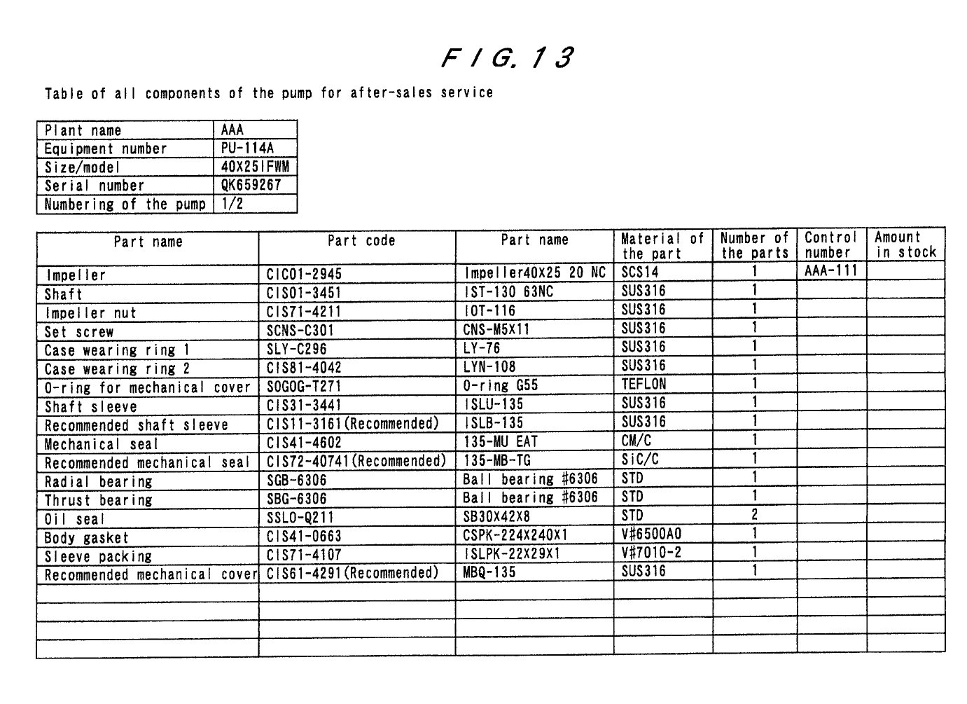

The user specifies a pump for the search by inputting a plant name and an equipment number into the fields 101 and 102 (Step 80). When the user clicks the search button 109 (Step 81), the plant name and the equipment number inputted into the fields 101, 102 are acquired by the search component (Step 82). The acquired data is set as search conditions for searching the compatible-parts database 2 stored on the floppy disk FD, and the search component extracts records matching these conditions from the compatible-parts database 2 (Step 83). Fields for the part name, the part code, the material of the part, the quantity, the control number, and the amount in stock are read from the extracted records (Step 84). The values for each of the fields are displayed in the display device 14, as shown in FIG. 13 (Step 85). Thus, by simply specifying the pump, the user can find all parts used in this pump and the amount in stock, so that the management of stocked spare parts can be facilitated.

An order with the part code used in the service provider's production process enables the service provider to deliver the part more quickly. Therefore, the user orders parts from the service provider based on the aforementioned part codes, and hence it is possible to shorten the delivery time of the parts. If a price for each of parts is prearranged between the service provider and the user, for example, then it is possible to simplify the service provider's process of estimation, so that a more effective sequence of processes including ordering, delivery to the user, invoicing, and payment can be achieved. This method is particularly effective in the case of managing parts via a network to be described later.

By using the parts management apparatus 1 described above, the user can instantaneously and easily find a service provider's part code from the user's own control number in order to submit an order based on this part code. Therefore, according to the system of the present invention, the user can manage parts based on the user's own control numbers used in the user's production process, and the service provider can manage parts based on the service provider's own part codes used in the service provider's production process. Thus, efficient management of parts can be achieved, and no confusion arises when the present system is introduced.

Further, the service provider can generate statistics of user's demand for parts and ordering frequency based on experience with a plurality of the users. This statistical data can be used to determine an appropriate number of parts for the user to stock, i.e., a ratio of stocked parts to the number of fluid machines, with consideration for production period and cost of such parts. For example, if the user should reserve parts at a ratio of 10%, then the user should stock one part for ten fluid machines. However, if there are a few fluid machines, the user should stock more parts than those at a ratio of 10%. Based on this example, at least one spare part must be stocked for one fluid machine. Accordingly, the number of stocked parts can be more appropriate as the number of fluid machines becomes larger. In the present invention, the service provider, e.g., the parts center described above, can manage and keep spare parts for fluid machinery belonging to a plurality of users altogether. Thus, it is possible to make the number of stocked parts appropriate by increasing the number of targeted fluid machines.

When one plant runs out of a certain part, the service provider may procure the part from another plant belonging to the same user or different users.

In the embodiment described above, the service provider can obtain data related to operating pumps from the user, as described in Step 2 of FIG. 1. Accordingly, this data can effectively be utilized as customer data for after-sales service, maintenance, or the like.

In the embodiment described above, the compatible-parts database 2 is stored on the floppy disk FD. However, the compatible-parts database 2 may be copied onto the hard disk 17 and be used.

While the present invention has been described in detail with reference to the preferred embodiment thereof, it would be apparent to those skilled in the art that many modifications and variations may be made therein without departing from the spirit and scope of the present invention. Next, some possible variations of the embodiment will be described below.

In the embodiment described above, a parts management apparatus (computer) installed on the user end is used to search the compatible-parts database. A parts management system may comprise client terminals (computers) 4 on the user end and a server (computers) 5 on the service provider end connected to each other via a network 3 such as the Internet. The compatible-parts database 2 is installed on the server 5, for example. The server 5 has a Web server function and a database search function. The server 5 can be accessed via the network 3 by a Web browser of the client terminals 4, so that the client terminals 4 can search the compatible-parts database 2 stored on the server 5. In this way, information can be quickly transmitted between the user and the service provider.

The user may order a part from the service provider via the network 3 to decrease the time required from order to delivery of the part. In this case, the user can further reduce the number of spare parts in stock, or eliminate the stock altogether.

In the embodiment described above, the service provider acquires data related to the operating pump and the control numbers from the user when creating a compatible-parts database. However, the service provider may regularly or irregularly acquire data related to removed and relocated pumps, for example, from the user for thereby updating the compatible-parts database based on this data. Thus, the service provider can always maintain the latest data in the compatible-parts database. Further, if specifications of parts and the like are modified, for example, then the service provider can revise the compatible-parts database with consideration for part compatibility. Furthermore, the trust between the service provider and the user can be strengthened.

Further, the status of parts stocked by the user or the service provider may be associated to parts in the compatible-parts database. When a part stocked by the user or the service provider is consumed, the stock status of the part in the compatible-parts database may be updated. In this case, it is possible to easily find the current state of stocked parts by the user, the service provider, or both, so that the management of stocked parts can be facilitated.

When both of the parts center and the pump manufacturer perform a part of the role of the service provider, the pump manufacturer creates the above compatible-parts database based on the actual production data and supplies this data to the user on an electronic media such as a floppy disk, or via the network. Then, the user orders parts from the parts center via the network or the like. The parts center delivers the parts to the user. The user can order the parts with the part code or the user's own control number. Preferably, the compatible-parts database is updated by the pump manufacturer having the actual production data.

Although the above descriptions involve existing pumps, the present invention can be applied to pumps to be newly installed. In this case, since the service provider knows what pumps are to be newly installed, it is not necessary for the user to enter prescribed data in the data sheet.

Further, configurations of the compatible-parts database and the windows displayed on the display of the parts management apparatus described above are not limited to the examples in the drawings and may be modified in various ways.

In the embodiment described above, the service provider provides the compatible-parts database to the user. Therefore, the user can easily find what common parts are used in the user's current fluid machinery. Accordingly, the user can reduce the number of spare parts which have been redundantly stocked to a minimum required number, or eliminate the stocking of spare parts altogether.

Further, according to the present invention, since it is possible to simplify service provider's process of estimation, receiving an order, manufacturing, and the like, the time required to deliver parts for fluid machinery such as pumps can be reduced. Accordingly, the user can reduce or eliminate the number of the user's own stocked spare parts for fluid machinery, thereby reducing the cost of stocking spare parts.

Although certain preferred embodiments of the present invention have been shown and described in detail, it should be understood that various changes and modifications may be made therein without departing from the scope of the appended claims.

What is claimed is:

1. A method for managing parts used in fluid machinery comprising:
creating a compatible-parts database for a plurality of fluid machinery in association with a common part used therein, said compatible-parts database identifying a part with a part identifier uniquely predetermined for said part.

2. A method for managing parts used in fluid machinery according to claim 1, further comprising:
associating said fluid machinery in said compatible-parts database with a control identifier assigned for a part used in said fluid machinery.

3. A method for ordering parts used in fluid machinery comprising:
creating a compatible-parts database for a plurality of fluid machinery of a user in association with a common part used therein, said compatible-parts database identifying a part with a part identifier uniquely predetermined for said part;
presenting said compatible-parts database to said user; and
ordering a part for fluid machinery from a service provider by referring to said compatible-parts database.

4. A method for ordering parts used in fluid machinery according to claim 3, further comprising:
presenting a control identifier assigned for a part used in said user's fluid machinery to said service provider; and
associating said fluid machinery in said compatible-parts database with said control identifier.

5. A method for ordering parts used in fluid machinery according to claim 4, wherein said user orders a part for fluid machinery from said service provider based on said control identifier corresponding to said part.

6. A method for ordering parts used in fluid machinery according to claim 3, wherein information communicated between said user and said service provider is transmitted via a storage medium storing said information, said storage medium capable of being read by a computer.

7. A method for ordering parts used in fluid machinery according to claim 3, wherein information communicated between said user and said service provider is transmitted by a client terminal on said user end and a server on said service provider end connected to each other via a network.

8. A method for ordering parts used in fluid machinery according to claim 3, wherein a parts center serving as a regional base for distributing parts performs a part of the role or the entire role of said service provider.

9. A method for ordering parts used in fluid machinery according to claim 3, wherein said service provider regularly or irregularly acquires information for fluid machinery employed by said user to update said compatible-parts database.

10. A method for ordering parts used in fluid machinery according to claim 3, further comprising:
associating said part in said compatible-parts database with the status of parts stocked by at least one of said service provider and said user; and
regularly or irregularly acquiring information for parts stocked by said at least one of said service provider and said user to update said compatible-parts database.

11. A method for ordering parts used in fluid machinery according to claim 3, wherein said service provider procures a part used in fluid machinery from the same users or different users.

12. A method for ordering parts used in fluid machinery according to claim 3, wherein said service provider manages maintenance of fluid machinery employed by said user based on information stored in said compatible-parts database.

13. A system for managing parts used in fluid machinery comprising:
a compatible-parts database for a plurality of fluid machinery of a user in association with a common part used therein, said compatible-parts database identifying a part with a part identifier uniquely predetermined for said part;
an input device for inputting a search condition for searching said compatible-parts database;
a search component for searching said compatible-parts database for a part of fluid machinery that matches said search condition inputted by said input device; and
a display device for displaying information on said part searched out by said searching component.

14. A system for managing parts used in fluid machinery according to claim 13, wherein said fluid machinery in said compatible-parts database is associated with a control identifier assigned for a part used in said user's fluid machinery.
